(19) United States
(12) Patent Application Publication
(10) Pub. No.: US 2016/0306188 A1
(43) Pub. Date: Oct. 20, 2016

(54) Neo-I (Neodymium Integrated)

(71) Applicant: Justin Gerald Head, Leesville, SC (US)

(72) Inventor: Justin Gerald Head, Leesville, SC (US)

(21) Appl. No.: 14/686,989

(22) Filed: Apr. 15, 2015

(51) Int. Cl. G02C 3/04; G02C 5/14

(52) U.S. Cl. CPC G02C 3/04; G02C 5/14; G02C 2200/02

(57) ABSTRACT

Eyeglasses having a set of magnets integrated into the temple “arms” for the purpose of safely and securely fastening said eyeglasses to an article of one's clothing and accessories by means of closing the “arms” together allowing the magnets to attract to one another causing a clip to be produced.

### SUMMARY OF INVENTION

The NEO-I describes the integration of a small and powerful neodymium magnet built into the “arms” of sunglasses and reading glasses for the purpose of safely securing said glasses to an article of a person's clothing. By closing the arms together, the user would be allowing the magnets to attract to each other thus causing a “clip” to be produced. When contact is made, the glasses are securely fastened to the wearer's clothing preventing them from being able to fall off freely. To disengage the magnetic “clip” the wearer would simply pull outward on the glasses thus loosening the magnetic attraction between the two poles and releasing the glasses.

### BRIEF DESCRIPTION OF DRAWINGS

FIG. 1 is an isometric view of sunglasses according to a preferred embodiment of invention.

FIG. 1A AND 1B are side cross-sectional views of said sunglass “arms”, showing the neodymium magnets.

FIG. 2 is a top view of the aforementioned sunglasses illustrating the open to closed position of the “arms” and the magnetic “clip” attraction.

FIG. 2A is an enlarged cross-sectional view of FIG. 2

FIG. 3 is a back view of the sunglasses in the closed position.

FIG. 3A is an enlarged cross-sectional view of FIG. 3

FIG. 4 is an illustration showing the desired purpose of the invention. To safely secure the sunglasses to an article of clothing by “clipping” the magnets together.

### DETAILED DESCRIPTION OF THE PREFERRED EMBODIMENT

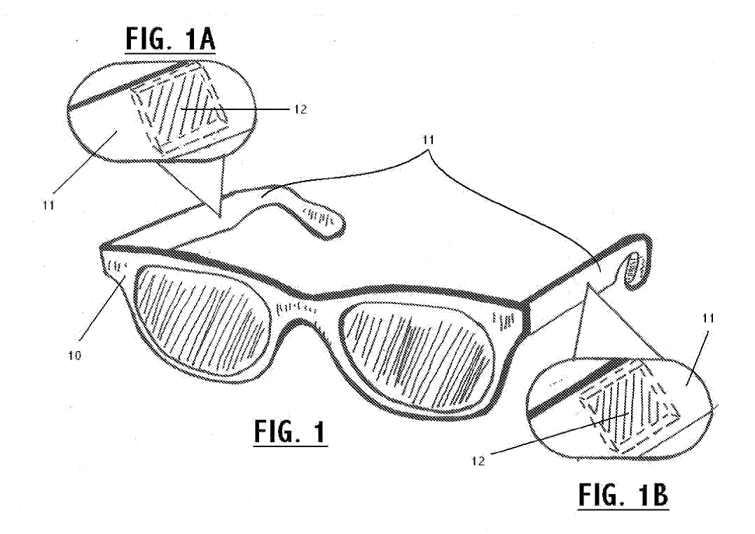

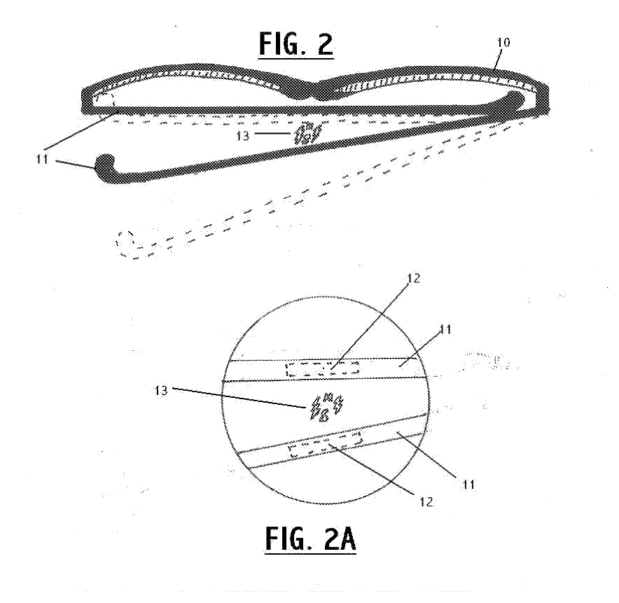

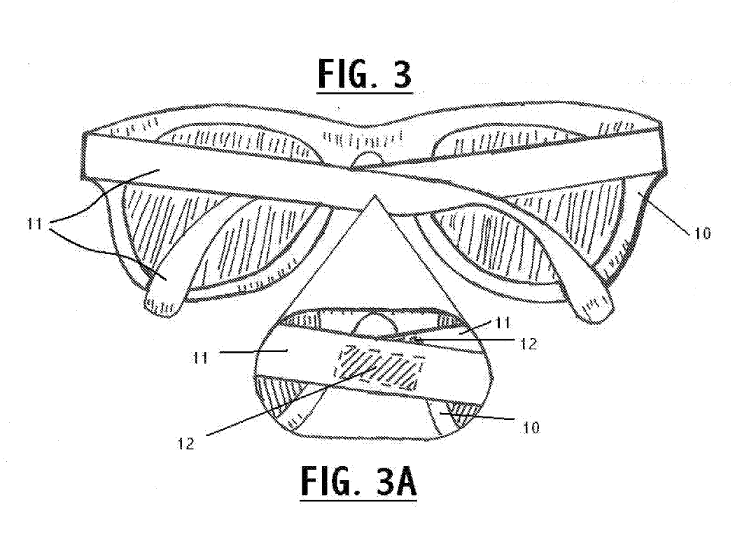

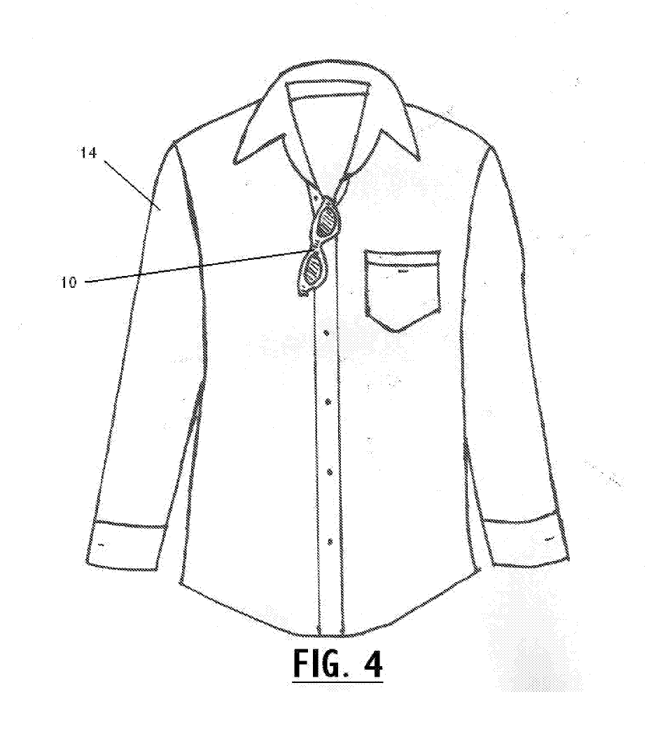

The sunglasses 10 have a powerful neodymium magnet 12 integrated into each of the “arms” 11. In FIG. 1, the sunglasses 10 are in the open position and the magnets 12 do not interact with one another. In FIG. 2, as the arms 11 are being closed the magnetic attraction 13 causes the arms 11 to “clip” together. As this “clipping” occurs, the desired result is achieved when fastened to an article of one's clothing 14 as best illustrated in FIG. 4.

What I claim is:

1. A pair of eyeglasses having an integrated Neodymium magnetic fastening feature, comprising:
A pair of lenses set in a frame; having
a pair of temple “ arms” extending from frame thereof; having
a set of neodymium magnets integrated into said temple “arms” whereby the eyeglasses can be securely fastened by means of Neodymium magnetic force to articles of one's clothing or accessories.

2. A pair of eyeglasses having an integrated magnetic fastening feature, comprising:
A pair of lenses set in a frame; having
a pair of temple “arms” extending from frame thereof; having
a set of magnets integrated into said temple “arms” whereby the eyeglasses can be securely fastened by means of magnetic force to articles of one's clothing and accessories.
